(19) United States
(12) Patent Application Publication
(10) Pub. No.: US 2011/0051913 A1
(43) Pub. Date: Mar. 3, 2011

(54) Method and System for Consolidating Communication

(76) Inventor: John Larsen Kesler, Salt Lake City, UT (US)

(21) Appl. No.: 12/875,188

(22) Filed: Sep. 3, 2010

Related U.S. Application Data
(60) Provisional application No. 61/239,762, filed on Sep. 3, 2009.

(51) Int. Cl. H04M 11/00

(52) U.S. Cl. 379/93.02

(57) ABSTRACT

A method and system are described for collating all avenues of communication through a single source. A user provides communication information to a service provider. The service provider associates this communication information with an identification code. The user then provides the identification code to new contacts instead of the user's communication information. When the contact tries to communicate with the user, the identification code directs the contact to the service provider. The service provider checks to see if the contact is permitted to communicate with the user. If permission is granted, the service provider routes the communication to the user, preferably in a format specified by the user.

### CROSS-REFERENCE TO RELATED APPLICATION

This application claims the benefit of provisional application Ser. No. 61/239762, filed Sep. 3, 2009, which is incorporated entirely herein by reference.

### BACKGROUND

There are 260 million active cell phones in the United States today, just roughly doubling that of landlines. This massive transformation has happened in merely 15 years and what was primarily used as a voice communications device, has now morphed into an advanced, multi-faceted multi-media instrument capable of browsing the Internet, listening to MP3 files, watching and sending videos, and managing entire companies. In short, the mobile phone has become the most powerful device by which people navigate and experience their world.

Although the mobile phone is capable of all these incredible features, there is still no wide-spread information management system that effectively routes content when you want it, how you want it and to where you want it. In short the world is missing the switchboard system for digital content and communication.

In addition, many users fear giving out phone numbers and other personal information because of the prevalent problem of spam and scams. Once a spam company gets a user's information into their database, preventing spam and unwanted calls can become nearly impossible.

### SUMMARY

The invention provides a method for consolidating communication security and control using communication routing. This allows users to freely provide contact information without worrying about disclosing personal information.

Having a single access point for communication creates a barrier that prevents other entities from learning the user's personal and possibly confidential information and allows users to communicate with others without providing permanent personal information like email addresses or phone numbers. This encourages users to freely give out contact information without experiencing the repercussions of mass unsolicited sales and marketing material. A single point of communication is a safety feature that protects the identity of its users.

Limiting access to a single access point also gives users the ability to remove themselves from lists or directories even after they have given their permission for communications. Users can provide their information to any entity without fear of spam or harassment.

A single point of communication is also advantageous to business because it alleviates the fear many consumers have about giving out personal information. Because this fear is alleviated, businesses are more readily able to create accurate opt in lists of users who are truly interested in their services.

### BRIEF DESCRIPTION OF THE FIGURES

FIG. 1 is a flowchart of an embodiment of the invention.

FIG. 2 is a depiction of an embodiment of the invention.

FIG. 3 is a flowchart of an example of the invention.

FIG. 4 is a depiction of how the invention transforms communication depending on the settings selected by the user.

FIG. 5 is a depiction of how the invention permits certain communication form certain entities.

FIG. 6 is a flowchart of how a business can use the invention.

FIG. 7 is a depiction of how the business can use the invention to send promotional communication to consumers.

### DETAILED DESCRIPTION

The invention is a communication hub that consolidates all forms of communication (voice, internet, Email, SMS, MMS, social networks, IM, and other new or existing communication techniques) into a single access point. A user 2 of the communication is be anyone who desires to consolidate their communication information, including people, communities, and businesses. A service provider 4 is an entity or entities that provide all or any part of the communication hub services described herein.

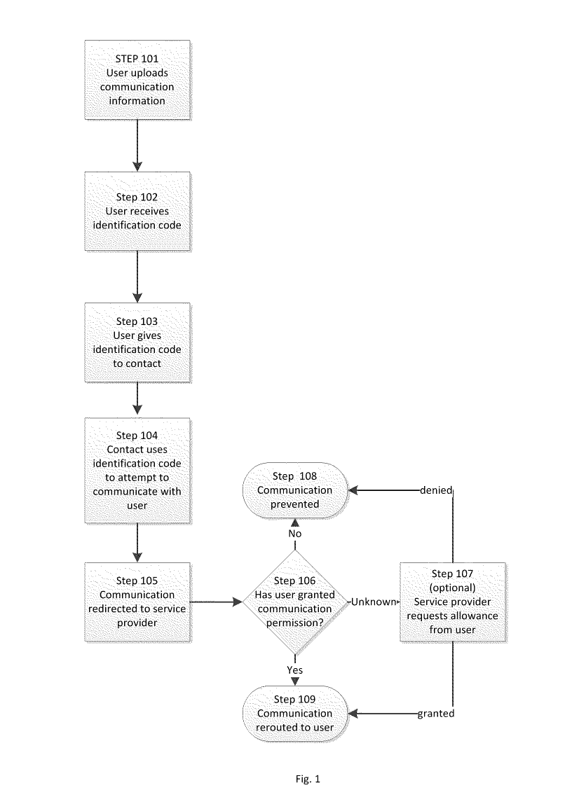

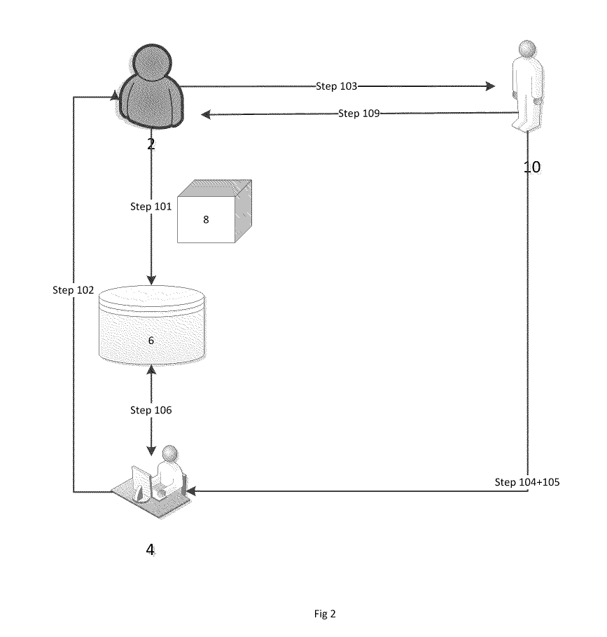

As shown in FIGS. 1 and 2, a user 2 uploads the user's contact information 8 into a database 6. The uploaded contact information can include addresses, mobile phone number, email, IM accounts, Google accounts, social networking accounts, and any other forms of electronic or physical communication. The user uploads this information during an account a registration process or provides the information to a service provider on an as-needed basis. Typically, service providers will have an electronic interface where the user can log into an account, input the information, and have the information automatically uploaded to the database.

During step 102, the service provider 4 provides the user 2 with one or more identification codes. Alternatively, the user can select the identification codes. Allowing the user to select the identification code(s) makes them easy to remember.

An identification code is any electronic means of identifying the user in the service provider's database. The service provider may have a separate identification code for each form of communication or one single identification code to represent all forms of communication. The service provide can also provide separate identification codes for various categories of communication, i.e. an identification code for peers, a separate one for businesses, and a third for entering into websites.

For example, the user may select “1234-1” and “1234-2” as the identification codes for telephone calls and text messages from peers, respectively. The same user can also select “4567-1” and “4567-2” as the identification code for telephone calls and text messages from merchants.

In step 103, the user 2 meets an entity 10 which desires further communication with the user. The entity could be a website, friend, peer, business, merchant, educational institution, community group, or any other source of potential communication. For example, the webpage could require an email address before allowing the user to access certain content. The user could also meet someone at a party, through a church function, at a store, etc. Instead of providing entity personally identifiable communication information, the user provides an identification code. The identification code provided can depend on how the user classifies the person and how the user prefers to receive communication.

In step 104, when the entity 10 tries to contact the user using the identification code, the entity instead contacts the service provider. The service provider can use any method to intercept the entity's communication with the user. The embodiments below are examples of how a service provider or user can accomplish this step.

In one embodiment, the identification code includes contact information for the service provider. For example, an identification code with an email address such as 1234@serviceprovider.com forces the entity to communicate through the service provider. The email address tells the service provider to forward the communication to the user associated with identification code “1234”.

A separate embodiment is where the identification code is a phone number associated with the service provider, such as 555-555-5555 ext 1234. Any texts or calls to this telephone number go to the service provider. The “1234” tells the service provider's switch board which user the entity is trying to contact.

A third embodiment has the entity send a text of the identification code using a mobile phone. After the text is sent, the entity is redirected to the appropriate user.

A fourth embodiment has the service provider control communication method. This way the service provider can directly intercept the email or call and redirect it as appropriate. For example if the user has an email address johndoe@service.com and the service provider is service.com, then the service provider can directly intercept all communication to service.com.

A fifth embodiment is having the entity sent an IM, text, or phone call to a specific number. After connecting to the number, the entity enters the service code and is redirected as appropriate.

In a sixth embodiment, the user has either configured existing software or has installed additional software on an electronic communication device to intercept the communication and reroute it to the service provider. The identification code is provided automatically to the service provider by the electronic device.

After the communication is intercepted, the service provider determines whether the communication is allowed.

In one embodiment, the service provider sends (using software or hardware) a request communication access or the actual communication user, typically using a method of communication selected by the user (the user's phone number, email address, SMS, etc.). The user can then decide whether to allow or reject the communication. The service provider can, optionally, include information about the entity initiating the communication so that the user can make an informed decision. Multiple identification codes are advantageous as they allow a user to easily identify the source of the communication.

After the communication is forwarded to the user, the user approves or disapproves the request.

In a second embodiment, the service accesses a permission table within the database. The service provider then determines whether communication is allowed based of permissions set by the user. For example the user can deny all access from one identification code but allow access from others. The user can also allow access only after receiving notice of the communication. The user could also decide to prevent all phone calls from a certain identification code but allow text messages. If the entity is using the correct means of communication and is not using a blocked identification code, the communication is considered permissible.

In a similar embodiment, the service provider has a database of allowed and rejected communication. The service provider also has an online interface that allows the user to go online and manage their communication preferences. The user can set defaults for unknown communication and decide whether to reject or deny known communication. Whenever the service provider receives communication intended for the user, the service provide consults the database and denies or grants the communication based on the user's preferences. The service provider may allow the user to access the database online at any time and see which communications were denied during the day.

The service provider can also track the user's response in order to either suggest how the user should respond to the communication or automate the denial or allowance process. In other words, if a user is always denying a certain identification code from communication, the service provider can prompt or automatically deny all requests from the same identification code.

In step 109, if the communication is allowed, the service provider reroutes the communication to the user. If the communication is rejected, the service provider terminates the communication.

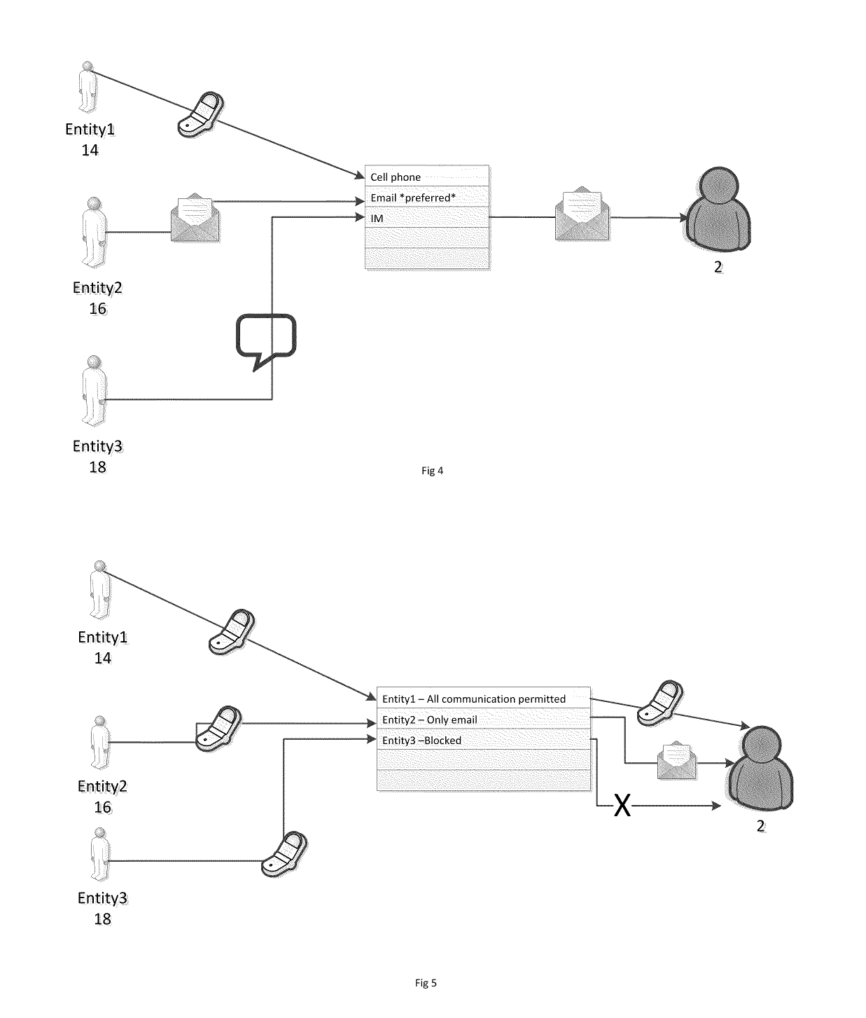

As shown in FIG. 4, the rerouted communication is not necessarily in the same format as the original. In one embodiment, the user can select which type of communication is preferred and has all communication translated into the selected format. For example, a user 2 may wish to receive all communication through email. If entity3 16 texts the user, and the user elects to allow the communication, the service provider will convert the text into an email and forward it to the preferred email address. Similarly, if a contact calls the user and leaves a voice mail message, the service provider sends the user an email containing the contents of the voice mail (such as by attaching an audio clip of the message or by converting the message into a text format using speech recognition software). Similarly, the service provider can forward emails to the user's phone as text message or as a phone call using automated reader software.

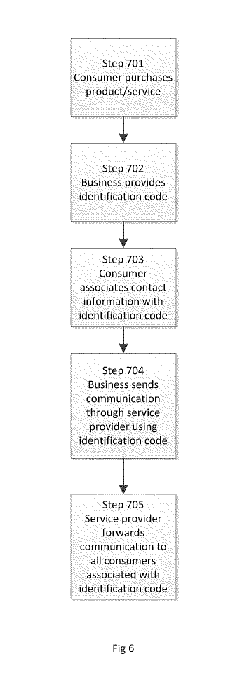

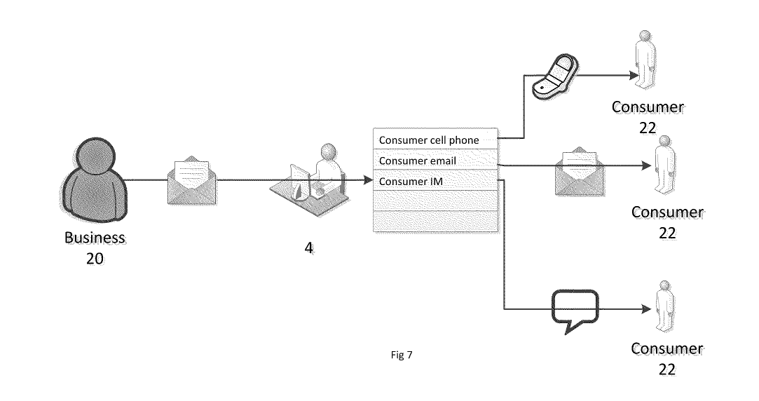

As shown in FIG. 5, the service provider can also route the information based on the type of communication. For example, a user may restrict merchants to only email communication and allow friends to send only IMs and make phone calls. Any other types of communication from a friend or merchant are converted to the appropriate communication type and sent to the user. The user can set this preference information by going into the user's account and selecting to have communication associated with a set identification code (the one identifying the entity type) sent in a specified format.

The user can also select different routing paths for specific contacts and types of communication. For example, the user 2 may elect to have all communication from Entity1 14 route to whatever communication method the entity elects to send, all voice communication from Entity2 16 route to email, all other communication from Entity2 route to text, and all communication with identification code “rosebud” 18 be denied access.

The user can decide at any time to allow or deny communication. All the user needs to do is log into the account and change the permission settings. This can be done on a per entity basis, on a per identification code basis, on a global basis, or in any other combination. This permission based scheme essentially creates a communication firewall between the user and the outside world.

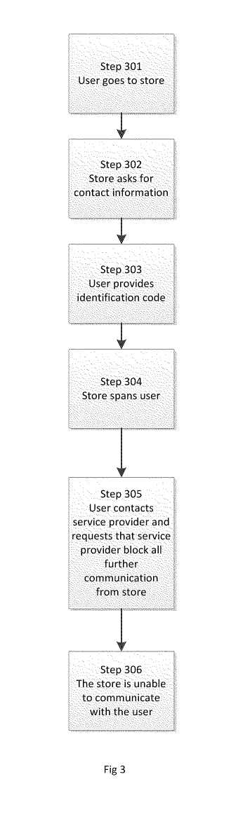

For example, shown in FIG. 3, a user goes to a store (online or in person). Before allowing the user to purchase goods, the store asks for the user's contact information. In step 303, the user does not provide their personal contact information. Instead the user gives an identification code to the store. In step 304, the user discovers that the store has sent numerous promotional offers. The user decides to revoke the store's communication privileges. The user logs into an online account and either revokes the store's contact permission or revokes the identification code provided to the store. The service provider will now automatically prevent any communication from the store or from the specified identification code (depending on what the user revoked) and the store is left without a way to communicate with the user.

As shown in FIGS. 7 and 8, businesses can use the invention as a marketing management tool. The business 20 can assign an identification code to consumer 22 depending on which product or service the consumer orders. When activating or purchasing a product or service, the consumer 22 enters their preferred means of communication, such as by email, text, IM, etc. This preferred means of communication is associated with the identification code. When the business 20 wants to send out communication, the business 20 sends the communication through the service provider 4 using the identification code. The service provider 4 then routes the communication to all the preferred means of communication of the consumers 22 associated with the identification code. This allows the business to communicate with consumers via multiple avenues with a single email.

Using an identification code, business can freely use cross platform statistic tracking and analytics can to provide purchasing trend without ever revealing personal information. Businesses can see information about what demographics have bought the products and other information without ever needing access to the actual user.

In another embodiment, the identification code is linked to a five-digit number called a short code. Users are allowed to access their account using the identification code and upload information about themselves. The account can be personalized with photos, locations, wants, likes and connections to friends and organizations that also have accounts, similar to common social networking sites. Businesses can then send promotions to an identification code associated with the account. If the user ever wishes to stop receiving the communication, they simply disable the remove the identification code from access.

For example, a business wants to get perform some mobile marketing. The business goes to the service provider's website and registers as a business and reserves a key word, such as travel. The service provider gives the business an identification code which the business then includes in all of its marketing campaigns, such as by stating “text travel to 91010”. Whenever a consumer texts the identification code to the service provider, the consumer's phone number is added to the business's database.

If the consumer texts their own identification code to the service provider, the consumer will still be added to the business's database. However, the business will only have the consumer's identification code, allowing the consumer to remove themselves from the mailing list at any time.

Users can also share information in this manner as identification codes can be linked to certain sets of information. A common scenario is where a user wants to share certain social profile information with their friends and different social profile information with a family member. In this case, the user sends their friends one identification code while the family members receive another. Only the information associated with the appropriate identification code are visible to the friends and family.

The invention can utilize cloud computing so that consumers can store contacts, archive communications and store and share an array of data from anywhere. This data then can be managed and synced to any mobile device allowing easy backup, transfer or storage of information.

An extension of the profile embodiment is to allow businesses to route and track information for pinpoint marketing through analytics and statistics. As stated previously, a business can create a database of clients using identification codes. These clients can elect to receive promotions and coupons directly to their mobile devices. However, if this identification code is also linked to social profile information, the business can also populate their databases with names, birthdates, residences, pictures and other information. The identification code allows the user to revoke the privilege to this

A temporary identification code can be used to ensure that all data appears in single consistent format and help prevent company liability. When a consumer texts a business's identification code, the service provider can respond with a temporary identification code for the consumer's method of communication. The consumer can then create an account with the service provider. If the method of communication was unauthorized by the individual (such as someone using a stolen email address), the service provider can easily disable all affected communication by disabling the temporary identification codes assigned to the user.

What is claimed is:

1. A method of communicating comprising:
Obtaining information,
Receiving a request to communicate using the information,
Checking to see if the requested communication is authorized, and
Taking action depending on whether or not the communication is authorized.

2. A method according to claim 1 where the action taken comprises denying communication with a user who provided the information.

3. A method according to claim 1 where the action taken comprises allowing communication with a user who provided the information.

4. A method according to claim 3 where the action taken is dependent on an action previously taken in response to a communication request.

5. A method according to claim 1 where checking to see if the requested communication is authorized comprises checking a permission database.

6. A method according to claim 1 where checking to see if the requested communication is authorized comprises requesting authorization from a user who supplied the communication information.

7. A method according to claim 1 further comprising associating the information with an identification code.

8. A method according to claim 7 where requesting to communicate comprises providing the identification code.

9. A method according to claim 8 where the request to communicate is initiated by an entity that obtained the identification code from a user who supplied the information.

10. A method according to claim 9 where the identification code is selected by a user who supplied the information.

11. A method according to claim 7 where the action taken is dependent on the identification code.

12. A method according to claim 7 further comprising modifying the communication associated with the request depending on the identification code.

13. A method according to claim 12 where the communication is transformed into a different format before being sent to a user associated with the information.

14. A method according to claim 1 where the action taken comprises routing the requested communication to a preferred method of communication.

15. A method according to claim 14 where the preferred method of communication is selected by the user who supplies the information.

16. A method according to claim 14 where the preferred method of communication depends on the entity imitating the communication request.

17. A method of communicating comprising:
Having a user upload information,
Assigning an identification code to the information, and
Restricting access to the information based on the identification code.

18. A method according to claim 17 where the information comprises information about how to communicate with the user.

19. A method according to claim 17 where the access restrictions are based on settings selected by the user.

20. A method according to claim 17 where the identification code is assigned by the user.

21. A method of communication comprising:
Providing information to a service provider,
Providing an identification code associated with the information to entities, and
Restricting access to the information based on the identification code.

22. A method of collecting information comprising:
Creating an identification code,
Distributing the identification code,
Having a user input the identification code, and
Storing information about the user in a database,

23. A method according to claim 22 further comprising using the identification code to send communication to the user.

24. A method according to claim 22 where the information comprises the user's preferred method of contact.

25. A method according to claim 23 where communication is transformed into a format that is accessible using the user's preferred method of contact.

26. A system for centralizing communication comprising
A service provider,
Communication information about a user,
An identification code associated with the communication information,
A routing system, and
Means for routing communication to the user through the routing system after receiving an identification code.
